(19) United States
(12) Patent Application Publication
(10) Pub. No.: US 2023/0303075 A1
(43) Pub. Date: Sep. 28, 2023

(54) VEHICLE CONTROLLER AND METHOD FOR CONTROLLING VEHICLE

(71) Applicant: TOYOTA JIDOSHA KABUSHIKI KAISHA, Aichi-ken (JP)

(72) Inventor: Kenichi ISHII, Miyoshi-shi (JP)

(21) Appl. No.: 18/184,664

(22) Filed: Mar. 16, 2023

(30) Foreign Application Priority Data
Mar. 23, 2022 (JP) 2022-046891

(51) Int. Cl. B60W 30/18; B60W 10/06; B60W 10/08

(52) U.S. Cl. CPC B60W 30/18127; B60W 10/06; B60W 10/08; B60W 2710/0644

(57) ABSTRACT

A controller for a vehicle executes, when an ignition switch is turned off before an engine speed increases to an autonomous speed that is a speed allowing for autonomous operation of an engine, an increase process that increases the engine speed to greater than or equal to the autonomous speed, and a stop position control that stops a piston at a predetermined position in a cylinder through regenerative braking that converts rotational energy of a crankshaft of the engine into electric power with a motor generator after the increase process is completed.

### BACKGROUND

### 1. Field

The following description relates to a vehicle controller and a method for controlling a vehicle.

### 2. Description of Related Art

Japanese Laid-Open Patent Publication No. 2005-180288 describes a vehicle controller that executes an idling stop control to stop the engine by cutting off fuel when predetermined stop conditions are satisfied. The stop conditions are, for example, that the vehicle speed is 0, the gearshift lever is at the neutral position or the parking position, the brake pedal is depressed, and/or the parking brake is applied. For example, when the vehicle stops at a traffic light, the engine may be stopped.

The above controller stops the engine so that the piston of one of the cylinders is stopped during the compression stroke at a predetermined position. This cylinder is filled with an air-fuel mixture. When restarting the engine, the controller drives the piston to a position proximate to the top dead center with a motor generator. Then, the controller ignites the air-fuel mixture with a spark plug.

The controller controls the piston to stop at a position that minimizes the torque required for the motor generator to restart the engine. Specifically, the controller stops the piston that is in the compression stroke at a position 60 to 90 degrees in crank angle before the top dead center.

The engine speed when the engine is idling is greater than or equal to the lower limit of the engine speed that allows for autonomous operation of the engine. After the engine is started, the operation of the engine may be stopped before the engine reaches a state that allows for autonomous operation of the engine. For example, when the ignition switch is turned off immediately after the engine is started, the engine will be stopped. In such a case, it will be difficult to control and stop the piston at the desired position for the reason described below.

When the operation of the engine is stopped, the compression reaction force of the air in the cylinder will decrease the engine speed and stop the crankshaft. When the engine speed is decreasing, a stop position control is executed to control and stop the position at a stop position. The stop position control adjusts the stop position of the piston through regenerative braking that converts the rotational energy of the crankshaft into electric power with the motor generator.

In a state before the engine initiates autonomous operation immediately after the engine is started, the flow of the air into the cylinder from an intake passage will be unstable. This will greatly vary the amount of the air in the cylinder. Thus, when the starting of the engine is stopped before the starting is completed and autonomous operation is initiated, the compression reaction force of the air in the cylinder will vary and hinder stop position control with the motor generator.

In contrast, when the engine speed is high enough to allow for autonomous operation of the engine, variation in the amount of the air in the cylinder will be reduced. Thus, the repulsive force generated by the air in the cylinder can be estimated. The position where the piston is stopped can be estimated by taking into consideration the repulsive force of the air. In such a case, the controller uses a detection value of a crank angle sensor to control negative torque of the motor generator. This facilitates piston stop position control.

As described above, stopping of the piston at the desired position may be difficult when the engine is stopped immediately after the engine is started and the engine speed is not high enough. Further, if the engine is stopped when the engine speed is not high enough, there will be less opportunities for executing control before the engine speed becomes 0. That is, there will be less opportunities to adjust negative torque of the motor generator for piston stop position control.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a controller for a vehicle is provided. The vehicle includes an engine provided with a cylinder and a motor generator connected to the engine. The controller includes processing circuitry. The processing circuitry is configured to execute, when an ignition switch is turned off before an engine speed increases to an autonomous speed that is a speed allowing for autonomous operation of the engine, an increase process that increases the engine speed to greater than or equal to the autonomous speed, and a stop position control that stops a piston at a predetermined position in the cylinder through regenerative braking that converts rotational energy of a crankshaft of the engine into electric power with the motor generator after the increase process is completed.

In another general aspect, a method for controlling a vehicle is provided. The vehicle includes an engine provided with a cylinder and a motor generator connected to the engine. The method includes, when an ignition switch is turned off before an engine speed increases to an autonomous speed that is a speed allowing for autonomous operation of the engine, executing an increase process that increases the engine speed to greater than or equal to the autonomous speed, and executing a stop position control that stops a piston at a predetermined position in the cylinder through regenerative braking that converts rotational energy of a crankshaft of the engine into electric power with the motor generator after the increase process is completed.

Other features and aspects will be apparent from the following detailed description, the drawings, and the claims.

### BRIEF DESCRIPTION OF THE DRAWINGS

FIG. 1 is a schematic diagram showing a controller according to one embodiment and a hybrid electric vehicle controlled by the controller.

FIG. 2 is a schematic diagram showing one of the cylinders of FIG. 1.

FIG. 3 is a table illustrating combustion cycles.

FIG. 4 is a flowchart showing a process executed by the controller of FIG. 1.

FIG. 5 is a time chart illustrating the operation of the embodiment, in which section (a) indicates whether an ignition switch is on or off, section (b) indicates the engine speed, and section (c) indicates whether an engine starting process flag is on or off.

FIG. 6 is a flowchart showing a process according to a modified example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

A vehicle controller according to one embodiment will now be described with reference to the drawings.

Structure of Hybrid Electric Vehicle 100

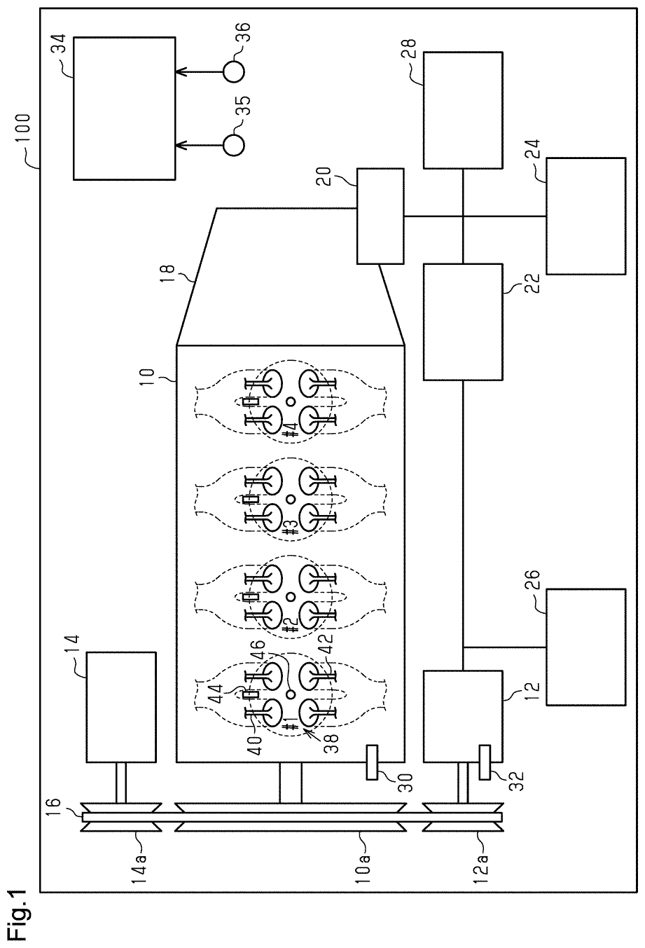

FIG. 1 shows a hybrid electric vehicle 100 (hereafter referred to as the vehicle 100) that is subject to control by a controller 34 according to an embodiment. The controller 34 is installed in the vehicle 100. The vehicle 100 includes an internal combustion engine 10 (hereafter referred to as the engine 10) and a motor generator 12. An air conditioning compressor 14 (hereafter referred to as the AC compressor 14) is installed in the vehicle 100. The engine 10 includes a crank pulley 10a. The motor generator 12 includes a motor generator pulley 12a. The AC compressor 14 includes an AC compressor pulley 14a. The crank pulley 10a, the motor generator pulley 12a, and the AC compressor pulley 14a are connected to one another by a belt 16.

In this manner, in the vehicle 100, the engine 10 is connected to the motor generator 12 by the belt 16. The controller 34 controls the vehicle 100 of such a configuration.

The vehicle 100 includes a transmission 18, a starter 20, a DC-DC converter 22, an auxiliary device 24, a high-voltage battery 26, and a low-voltage battery 28. The high-voltage battery 26 may be a Li-ion battery. The low-voltage battery 28 may be a lead-acid battery. The transmission 18 is connected to the engine 10. The starter 20 is connected to the transmission 18. The starter 20 drives the transmission 18. The starter 20 starts the engine 10 by driving the transmission 18. The high-voltage battery 26 is connected to the motor generator 12 and the DC-DC converter 22. The motor generator 12 is supplied with electric power from the high-voltage battery 26 to start the engine 10. The low-voltage battery 28 is connected to the starter 20, the DC-DC converter 22, and the auxiliary device 24.

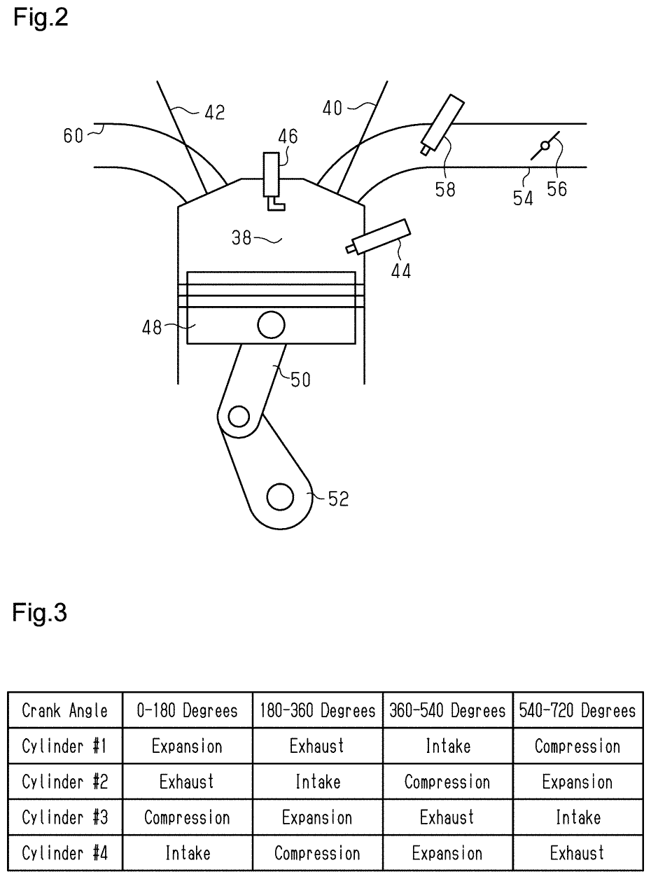

As shown in FIG. 1, the engine 10 includes four cylinders #1, #2, #3, #4. FIG. 2 is a schematic diagram showing one of the four cylinders #1 to #4 of FIG. 1.

An intake passage 54 is connected to cylinders #1 to #4. Intake air from outside the engine 10 is drawn through the intake passage 54 into cylinders #1 to #4. An exhaust passage 60 is connected to cylinders #1 to #4. Exhaust gas from cylinders #1 to #4 is discharged through the exhaust passage 60 out of the engine 10.

A throttle valve 56 is arranged in the intake passage 54. The throttle valve 56 adjusts the amount of intake air flowing through the intake passage 54. A port injection valve 58 is arranged in the intake passage 54 in the vicinity of each cylinder. The port injection valve 58 injects fuel into the intake passage 54 to supply the fuel to the corresponding cylinder through the intake passage 54.

A piston 48 is arranged inside each cylinder. The piston 48 is connected to a crankshaft 52 by a connecting rod 50.

In each of cylinders #1 to #4, when an intake valve 40 opens, air is drawn into a combustion chamber 38. An in-cylinder injection valve 44 injects fuel into the combustion chamber 38. An ignition device 46 produces a spark discharge that ignites the air-fuel mixture in the combustion chamber 38. The air-fuel mixture burns in the cylinder and reciprocates the piston 48 inside the cylinder. The energy generated by the combustion is converted into rotational energy of the crankshaft 52 of the engine 10. The crankshaft 52 of the engine 10 is connected to the transmission 18. The burned air-fuel mixture is discharged from the combustion chamber 38 when an exhaust valve 42 opens.

The controller 34 includes a microcomputer having a CPU, ROM, RAM, an input/output interface, and the like. The controller 34 processes signals in accordance with programs stored in the ROM while using the transitory storage functionality of the RAM. The controller 34 controls the engine 10, the motor generator 12, and the like.

The engine 10 includes a crank angle sensor 30. The controller 34 obtains a crank angle from the crank angle sensor 30. The controller 34 calculates the time derivative of the obtained crank angle to obtain the speed of the engine 10, or the engine speed. The motor generator 12 includes a motor generator speed sensor 32. The controller 34 obtains the speed of the motor generator 12 from the motor generator speed sensor 32.

The vehicle 100 includes an ignition switch 35. The controller 34 obtains a signal indicative of whether the ignition switch 35 is on or off from the ignition switch 35.

The vehicle 100 includes a speed sensor 36 that detects the speed of the vehicle 100. The controller 34 obtains a signal indicative of the speed of the vehicle 100 from the speed sensor 36.

Load on Motor Generator 12 when Motor Generator 12 Starts Engine 10

The motor generator 12 may start the engine 10 when the engine speed is 0.

As shown in FIG. 3, cylinder #1 is in the expansion stroke when the crank angle is 0 to 180 degrees. Cylinder #1 is in the exhaust stroke when the crank angle is 180 to 360 degrees. Cylinder #1 is in the intake stroke when the crank angle is 360 to 540 degrees. Cylinder #1 is in the compression stroke when the crank angle is 540 to 720 degrees.

As shown in FIG. 3, cylinder #2 is in the exhaust gas when the crank angle is 0 to 180 degrees. Cylinder #2 is in the intake stroke when the crank angle is 180 to 360 degrees. Cylinder #2 is in the compression stroke when the crank angle is 360 to 540 degrees. Cylinder #2 is in the expansion stroke when the crank angle is 540 to 720 degrees.

As shown in FIG. 3, cylinder #3 is in the compression stroke when the crank angle is 0 to 180 degrees. Cylinder #3 is in the expansion stroke when the crank angle is 180 to 360 degrees. Cylinder #3 is in the exhaust stroke when the crank angle is 360 to 540 degrees. Cylinder #3 is in the intake stroke when the crank angle is 540 to 720 degrees.

As shown in FIG. 3, cylinder #4 is in the intake stroke when the crank angle is 0 to 180 degrees. Cylinder #4 is in the compression stroke when the crank angle is 180 to 360 degrees. Cylinder #4 is in the expansion stroke when the crank angle is 360 to 540 degrees. Cylinder #4 is in the exhaust stroke when the crank angle is 540 to 720 degrees.

In this manner, one of the four cylinders #1 to #4 is in the compression stroke and another one of the four cylinders #1 to #4 is in the expansion stroke at any crank angle. The intake valve 40 and the exhaust valve 42 are closed in the cylinder that is in the compression stroke or the expansion stroke. Thus, the piston 48 of the cylinder in the compression stroke or the expansion stroke resists movement when the motor generator 12 starts the engine 10. This applies a load to the motor generator 12. For example, if the motor generator 12 starts the engine 10 when the crank angle is 0 degrees, cylinder #1 and cylinder #3 apply a load to the motor generator 12.

The piston 48 may be at the bottom dead center when initiating an engine starting process that increases the engine speed from 0. In this case, the motor generator 12 needs to move the piston 48 from the beginning of the compression stroke to the end of the compression stroke. In the compression stroke, the intake valve 40 and the exhaust valve 42 are closed. Thus, the repulsive force of the compressed air applies a large load to the motor generator 12.

Process Executed by Controller 34

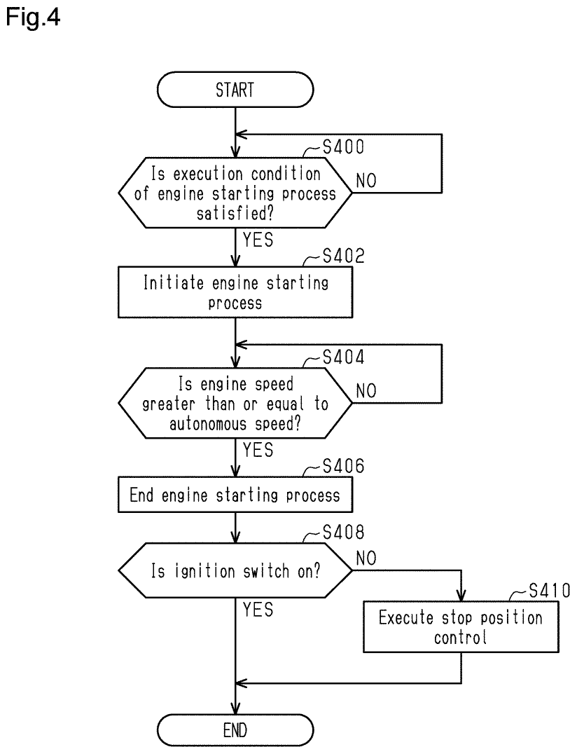

A process executed by the controller 34 of FIG. 1 will now be described with reference to FIG. 4. The controller 34 starts the process shown in FIG. 4 on condition that the ignition switch 35 is on and the engine speed is 0. For example, the controller 34 starts the process shown in FIG. 4 if the ignition switch 35 is turned on when the vehicle 100 has not been operating. The controller 34 also starts the process shown in FIG. 4 if the engine speed becomes 0 when the ignition switch 35 is on.

In step S400, the controller 34 determines whether the execution condition of the engine starting process is satisfied. When the controller 34 makes a negative determination in step S400 (step S400: NO), the controller 34 repeats step S400. When the controller 34 makes an affirmative determination in step S400 (step S400: YES), the controller 34 proceeds to step S402. In step S402, the controller 34 initiates the engine starting process.

The engine starting process will now be described. The engine starting process increases the engine speed from 0 to an autonomous speed that allows for autonomous operation of the engine 10. First, the controller 34 cranks the engine 10 with the motor generator 12. If combustion start conditions are satisfied when the cranked crankshaft 52 is being rotated, the controller 34 starts fuel injection control and ignition control of the engine 10. When the combustion start conditions are satisfied, combustion will be stable in the engine 10. Combustion will become stable when the piston 48 is lowered at a certain speed so that a certain amount of air is drawn into the cylinder. Thus, the combustion start conditions include, for example, the engine speed being greater than or equal to a lower limit.

The execution condition of the engine starting process immediately after the ignition switch 35 is turned on in a state in which the vehicle 100 is not operating will now be described.

If the ignition switch 35 is turned on when the vehicle 100 is not operating, the controller 34 determines whether first idling stop conditions are satisfied. In the present embodiment, the first idling stop conditions are satisfied when condition (A), condition (B), condition (C), and condition (D) are all satisfied. Condition (A): The vehicle 100 is at a standstill from the point of time at which the ignition switch 35 is turned on. Condition (B): The state of charge (SOC) of the high-voltage battery 26 is greater than or equal to a first SOC threshold value, and the state of charge of the low-voltage battery 28 is greater than or equal to a second SOC threshold value. Condition (C): Warming of the engine 10 is not required. Condition (D): The temperature of an evaporator is lower than or equal to a predetermined temperature. The first idling stop conditions are not satisfied when any one of condition (A), condition (B), condition (C), and condition (D) is not satisfied.

When the first idling stop conditions are not satisfied, the controller 34 determines that the execution condition of the engine starting process is satisfied (step S400: YES). In other words, the controller 34 initiates the engine starting process when the first idling stop conditions are not satisfied. As will be described below, the first idling stop process may be prohibited at the point of time at which the ignition switch 35 is turned on. In such a case, the controller 34 initiates the engine starting process immediately after the ignition switch 35 is turned on.

When the first idling stop conditions are satisfied, the controller 34 determines that the execution condition of the engine starting process is not satisfied (step S400: NO). When the first idling stop conditions are satisfied, the controller 34 executes the first idling stop process. The first idling stop process maintains the engine speed at 0 from the point of time at which the ignition switch 35 is turned on.

The execution condition of the engine starting process when the engine speed becomes 0 in a state in which the ignition switch 35 is on will now be described. A case in which the ignition switch 35 is on and the engine 10 is running will be described. The controller 34 automatically stops the engine 10 when predetermined stop conditions are satisfied, such as the brake pedal being depressed and the vehicle 100 being at a standstill for a predetermined period. Thus, the engine speed becomes 0 in a state in which the ignition switch 35 is on. When the depressed brake pedal is released, the controller 34 determines that the execution condition of the engine starting process is satisfied (step S400: YES). When the brake pedal is continuously depressed, the controller 34 determines that the execution condition of the engine starting process is not satisfied (step S400: NO).

In step S402, the controller 34 initiates the engine starting process and then proceeds to step S404. In step S404, the controller 34 determines whether the engine speed is greater than or equal to the autonomous speed. The autonomous speed is a speed allowing for autonomous operation of the engine 10. When the controller 34 makes a negative determination in step S404 (step S404: NO), the controller 34 repeats step S404. When the controller 34 makes an affirmative determination in step S404 (step S404: YES), the controller 34 proceeds to step S406. In step S406, the controller 34 ends the engine starting process.

Steps S402, S404, and S406 continue execution of the engine starting process regardless of whether the ignition switch 35 is turned off during execution of the engine starting process. Thus, when the ignition switch 35 is turned off before the engine speed increases to the autonomous speed, the controller 34 executes an increase process. The increase process increases the engine speed until the engine speed becomes greater than or equal to the autonomous speed. The increase process includes cranking the engine 10 with the motor generator 12 and performing combustion in the cylinders until the engine speed becomes greater than or equal to the autonomous speed. In this case, even when the ignition switch 35 is turned off, the controller 34 continues cranking and performing combustion in the cylinders until the engine speed becomes greater than or equal to the autonomous speed. The controller 34 executes the increase process in this manner.

In step S406, the controller 34 ends the engine starting process and then proceeds to step S408. In step S408, the controller 34 determines whether the ignition switch 35 is on. When the controller 34 makes an affirmative determination in step S408 (step S408: YES), the controller 34 ends the process. When the controller 34 makes a negative determination in step S408 (step S408: NO), the controller 34 proceeds to step S410.

In step S410, the controller 34 executes the stop position control. The stop position control is executed after the increase process is completed. The stop position control stops the piston 48 of the cylinder at a predetermined position through regenerative braking that converts the rotational energy of the crankshaft 52 of the engine 10 into electric power with the motor generator 12. The predetermined position is a position within a predetermined range that does not include the vicinity of the top dead center and the vicinity of the bottom dead center of the piston 48. For example, the controller 34 stops the piston 48 at the crank angle of 30 to 150 degrees. The stop position control will now be described. The motor generator 12 performs regenerative braking to decrease the engine speed. Specifically, negative torque that reduces rotation of the crankshaft 52 of the engine 10 is applied to the engine 10. Target control data indicating the relationship between a target value of the crank angle and a target value of the engine speed is preset for execution of the stop position control. The controller 34 adjusts the negative torque in accordance with the target control data.

In step S410, the controller 34 stops the piston 48 and then ends the process. When the controller 34 fails to stop the piston 48 at a predetermined position in the stop position control, the controller 34 prohibits the first idling stop process. After such a failure, if the controller 34 successfully executes the stop position control, the controller 34 permits execution of the first idling stop process.

### Operation of Embodiment

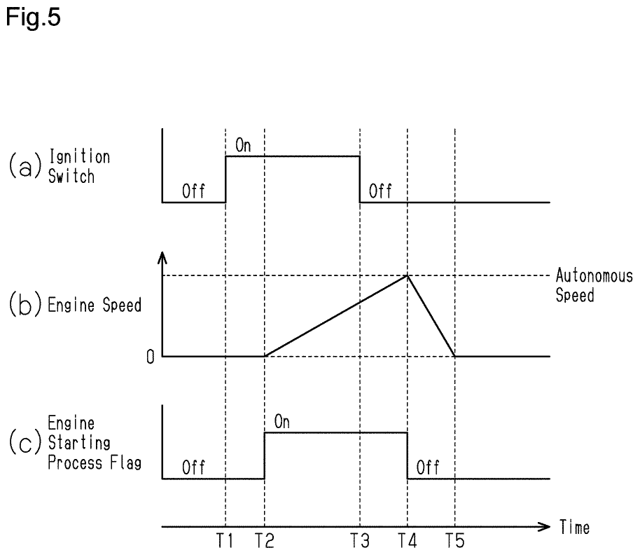

The operation when the ignition switch 35 is turned off during execution of the engine starting process after the first idling stop process will now be described with reference to FIG. 5.

As shown in section (a) of FIG. 5, the ignition switch 35 is turned on at time T1. In the example shown in FIG. 5, the first idling stop conditions are satisfied from time T1 to time T2. Thus, the engine speed is maintained at 0 from time T1 to time Tt2.

In the example shown in FIG. 5, the first idling stop conditions are no longer satisfied at time T2. Thus, as shown in section (c) of FIG. 5, the engine starting process flag is set from off to on at time T2. This initiates the engine starting process. As shown in section (b) of FIG. 5, the engine speed begins to increase from time T2.

As shown in section (a) and section (b) of FIG. 5, at time T3, the ignition switch 35 is turned off before the engine speed increases to the autonomous speed. The engine speed increases from time T3 to time T4 although the ignition switch 35 is turned off at time T3. That is, the controller 34 executes the increase process from time T3 to time T4.

As shown in section (b) of FIG. 5, the engine speed reaches the autonomous speed at time T4. As shown in section (c) of FIG. 5, the engine starting process flag is set to off when the engine speed reaches the autonomous speed. The controller 34 executes the stop position control from time T4 to time T5.

### Advantages of the Embodiment

(1) As long as the engine speed is increased to the autonomous speed or greater, the flow of air from the intake passage 54 into each cylinder is stable. This reduces variation in the amount of air that enters the cylinder. Thus, with the controller 34, the compression reaction force of the air in the cylinder is uniform when the stop position control is initiated. This allows the controller 34 to stop the piston 48 at the desired position through the stop position control even when the ignition switch 35 is turned off before the start process is completed.

(2) In a comparative example, combustion is not performed in the cylinder. In the above embodiment, combustion is performed in the cylinder during the increase process. Thus, the above embodiment completes the increase process earlier than the comparative example. In this case, a user will feel less awkward since the engine speed will continue to increase even though the ignition switch 35 is turned off.

(3) With the above configuration, in order to execute the first idling stop process, the stop position control will need to have been successfully executed in the previous trip. The trip refers to a period from when the ignition switch 35 is turned on to when the ignition switch 35 is turned off and the vehicle 100 stops operation.

The relationship between the first idling stop process and the stop position control will now be described. The engine starting process is executed after the first idling stop by cranking the engine 10 with the motor generator 12. If the piston 48 is at the bottom dead center when initiating the engine starting process, the motor generator 12 needs to move the piston 48 from the beginning of the compression stroke to the end of the compression stroke. In the compression stroke, the intake valve 40 and the exhaust valve 42 are closed, and the repulsive force of compressed air applies a large load to the motor generator 12. In order to avoid the application of excessive load to the motor generator 12, the controller 34 prohibits the first idling stop process when failing to stop the piston 48 at a predetermined position in the stop position control.

With the above configuration, in which the controller 34 prohibits the first idling stop process when failing to stop the piston 48 at a predetermined position in the stop position control, the execution of the stop position control after completion of the increase process is particularly effective. That is, when the stop position control is successfully executed, the first idling stop process can be easily executed. This improves fuel efficiency.

### Modifications

The present embodiment may be modified as described below. The present embodiment and the following modifications can be combined as long as the combined modifications remain technically consistent with each other.

In the above embodiment, the engine 10 is connected to the motor generator 12 by the belt 16. Instead, the engine 10 may be connected to the motor generator 12 by one or more gears. Alternatively, the engine 10 may be connectable to the motor generator 12 by a clutch.

In the above embodiment, the quantity of the cylinders is four. However, this is only an example. The quantity of the cylinders may be one or more.

The above embodiment does not include a clutch that can connect or disconnect the engine 10 to or from the crank pulley 10a. A clutch may be arranged between the engine 10 and the crank pulley 10a.

In the above embodiment, the high-voltage battery 26 and the low-voltage battery 28 are installed in the vehicle 100. However, this is only an example. The vehicle 100 only needs to include a battery that supplies electric power to the motor generator 12.

The combustion cycles may be changed. In the above embodiment, air-fuel mixture is ignited in cylinder #1, cylinder #3, cylinder #4, and cylinder #2 in this order. Alternatively, air-fuel mixture may be ignited in cylinder #1, cylinder #2, cylinder #4, and cylinder #3 in this order.

In the above embodiment, the first idling stop conditions are satisfied when condition (A), condition (B), condition (C), and condition (D) are all satisfied. Alternatively, one or more of condition (B), condition (C), and condition (D) may be omitted.

In the above embodiment, the engine starting process includes cranking the engine 10 with the motor generator 12. Instead or in addition, the engine starting process may include cranking the engine 10 by driving the transmission 18 with the starter 20.

In the above embodiment, the increase process includes cranking the engine 10 with the motor generator 12 and performing combustion in the cylinders until the engine speed becomes greater than or equal to the autonomous speed. That is, combustion in the cylinders continues until the engine starting process ends. Instead, combustion in the cylinders may be stopped before the engine starting process ends.

In the above embodiment, the stop position control is executed when the ignition switch 35 is off after the engine starting process ends. The stop position control may be executed when the above predetermined stop conditions are satisfied.

After an affirmative determination is made in step S408, the engine speed can be expected to be greater than or equal to the autonomous speed. The stop position control may also be executed when the ignition switch 35 is turned off in such a state.

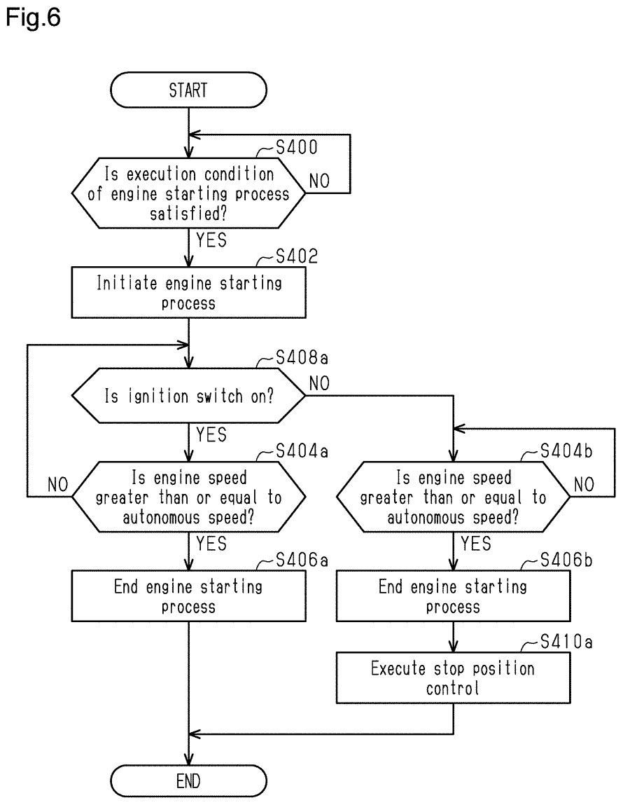

In the above embodiment, the controller 34 determines whether the ignition switch 35 is on after the engine starting process ends as shown in steps S406 and S408 of FIG. 4. However, this is only an example. As shown in FIG. 6, the controller 34 may determine whether the ignition switch 35 is on immediately after initiating the engine starting process (step S408a).

When the controller 34 makes an affirmative determination in step S408a (step S408a: YES), the controller 34 proceeds to step S404a. In step S404a, the controller 34 determines whether the engine speed is greater than or equal to the autonomous speed. When the controller 34 makes a negative determination in step S404a (step S404a: NO), the controller 34 returns to step S408a. When the controller 34 makes an affirmative determination in step S404a (step S404a: YES), the controller 34 proceeds to step S406a. In step S406a, the controller 34 ends the engine starting process. Then, the controller 34 ends the process.

When the controller 34 makes a negative determination in step S408a (step S408a: NO), the controller 34 proceeds to step S404b. In step S404b, the controller 34 determines whether the engine speed is greater than or equal to the autonomous speed. When the controller 34 makes a negative determination in step S404b (step S404b: NO), the controller 34 repeats step S404b. When the controller 34 makes an affirmative determination in step S404b (step S404b: YES), the controller 34 proceeds to step S406b. In step S406b, the controller 34 ends the engine starting process. Then, the controller 34 proceeds to step S410a. In step S410a, the controller 34 executes the stop position control. Then, the controller 34 ends the process.

The operation when the ignition switch 35 is turned off during the engine starting process after the first idling stop process will now be described with reference to FIG. 6.

The ignition switch 35 is turned on in a state in which the vehicle 100 is not operating. When the first idling stop conditions are satisfied (step S400: NO), the engine speed is maintained at 0.

When the first idling stop conditions are not satisfied (step S400: YES), the engine starting process is initiated (step S402). Thus, the engine speed increases from 0.

Even when the ignition switch 35 is turned off before the engine speed increases to the autonomous speed (step S404a: NO, step S408a: NO), the engine starting process is continued (step S404b: NO). That is, the controller 34 executes the above increase process while repeating step S404b.

When the engine speed reaches the autonomous speed (step S404b: YES), the controller 34 ends the engine starting process in step S406b. Then, the controller 34 executes the above stop position control in step S410a.

In the above embodiment, the increase process is executed when the ignition switch 35 is turned off before the engine speed of the engine 10 increases to the autonomous speed after initiation of the engine starting process that increases the engine speed from 0. However, this is only an example. The engine starting process may increase the engine speed from a value greater than 0 to the autonomous speed. This process will now be described below. The controller 34 automatically stops the engine 10 when the above predetermined stop conditions are satisfied in a state in which the ignition switch 35 is on. However, the automatic stopping may be interrupted. Specifically, the engine 10 may have to be driven before the engine 10 is stopped. In other words, from a state in which the engine speed is decreasing toward 0, the engine speed may be increased to the autonomous speed. The ignition switch 35 may be turned off when the engine speed is still less than the autonomous speed. In this case, the increase process may be executed. The stop position control may be executed after the increase process is completed.

In the above embodiment, the controller 34 includes a CPU, ROM, and RAM and executes software processing. However, this is only an example. For example, the controller 34 may include a dedicated hardware circuit (such as ASIC) that executes at least part of the software processes executed in the above embodiment. That is, the controller 34 may be modified to have any one of the following configurations (a) to (c). (a) The controller 34 includes a processor that executes all processes according to programs and a program storage device such as ROM that stores the programs. That is, the controller 34 includes a software execution device. (a) The controller 34 includes a processor that executes part of processes according to programs and a program storage device. The controller 34 further includes a dedicated hardware circuit that executes the other processes. (c) The controller 34 includes a dedicated hardware circuit that executes all processes. A plurality of software execution devices and/or a plurality of dedicated hardware circuits may be provided. In other words, the above processes may be executed by processing circuitry that includes at least one of a software executing device and a dedicated hardware circuit. A plurality of software execution devices and a plurality of dedicated hardware circuits may be included in the processing circuitry. The program storage device, or computer readable media, includes any type of media that are accessible by general-purpose computers and dedicated computers.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A controller for a vehicle, the vehicle including an engine provided with a cylinder and a motor generator connected to the engine, the controller comprising:
processing circuitry, wherein
the processing circuitry is configured to execute:
when an ignition switch is turned off before an engine speed increases to an autonomous speed that is a speed allowing for autonomous operation of the engine, an increase process that increases the engine speed to greater than or equal to the autonomous speed; and
a stop position control that stops a piston at a predetermined position in the cylinder through regenerative braking that converts rotational energy of a crankshaft of the engine into electric power with the motor generator after the increase process is completed.

2. The controller according to claim 1, wherein the increase process includes cranking the engine with the motor generator and performing combustion in the cylinder until the engine speed becomes greater than or equal to the autonomous speed.

3. The controller according to claim 1, wherein
when a first idling stop condition is satisfied, including the vehicle being at a standstill from a point of time at which the ignition switch is turned on, the processing circuitry is configured to execute a first idling stop process, the first idling stop process maintaining the engine speed at 0 from the point of time at which the ignition switch is turned on,
when the first idling stop condition is not satisfied, the processing circuitry is configured to initiate an engine starting process that increases the engine speed from 0 by cranking the engine with the motor generator, and
when the ignition switch is turned off before the engine speed increases to the autonomous speed, the processing circuitry is configured to execute:
the increase process that increases the engine speed by cranking the engine with the motor generator; and
the stop position control that stops the piston at the predetermined position in the cylinder after the increase process is completed.

4. The controller according to claim 3, wherein, when failing to stop the piston at the predetermined position in the stop position control, the processing circuitry is configured to prohibit the first idling stop process.

5. A method for controlling a vehicle, the vehicle including an engine provided with a cylinder and a motor generator connected to the engine, the method comprising:
when an ignition switch is turned off before an engine speed increases to an autonomous speed that is a speed allowing for autonomous operation of the engine, executing an increase process that increases the engine speed to greater than or equal to the autonomous speed; and
executing a stop position control that stops a piston at a predetermined position in the cylinder through regenerative braking that converts rotational energy of a crankshaft of the engine into electric power with the motor generator after the increase process is completed.
